(19) United States
(12) Patent Application Publication
(10) Pub. No.: US 2012/0095912 A1
(43) Pub. Date: Apr. 19, 2012

(54) SYSTEMS AND METHODS FOR ELECTRONIC PURCHASE TRANSACTION PROCESSING

(75) Inventors: Sheila H. James, Ottawa (CA); Marwan Forzley, Larchmont, NY (US); John A. MacMillan, Carp (CA); David Koch, Wilton, CT (US); Samer Forzley, Ottawa (CA)

(73) Assignee: Western Union Financial Services, Inc., Englewood, CO (US)

(21) Appl. No.: 13/275,080

(22) Filed: Oct. 17, 2011

Related U.S. Application Data
(60) Provisional application No. 61/393,721, filed on Oct. 15, 2010.

(51) Int. Cl. G06Q 20/22

(52) U.S. Cl. 705/40

(57) ABSTRACT

A system for initiating a payment to a merchant from a bill payment system for a purchaser in an electronic purchase transaction is provided. The purchaser may be a subscriber of the bill payment subsystem and the system may include a gateway subsystem. The gateway subsystem may receive electronic purchase transaction information. The electronic purchase transaction information may include a payment request authorized by the purchaser and an identifier associated with the merchant. The gateway subsystem may further determine that the purchaser is registered with the gateway subsystem, and send the payment request to the bill payment subsystem of which the purchaser is the subscriber. The gateway subsystem may also receive a payment notification from the bill payment subsystem, and cause a first payment to be made from a first account associated with the gateway subsystem to a second account associated with the merchant.

### CROSS-REFERENCE TO RELATED APPLICATIONS

This application claims priority to U.S. Provisional Patent Application No. 61/393,721 filed Oct. 15, 2010, entitled “SYSTEM AND METHOD FOR ELECTRONIC PURCHASE TRANSACTION PROCESSING,” the entire disclosure of which is hereby incorporated by reference, for all purposes, as if fully set forth herein.

### BACKGROUND OF THE INVENTION

This invention relates generally to payment processing. More specifically the invention relates to the processing of cash payments for electronic purchase transactions.

Online transactions are becoming prevalent as more and more people gain affordable access to the Internet. While some consumers are comfortable with the security provided when performing an online purchase and authorizing its associated payment transaction, others are not. Such transactions typically include transmission of credit card information or other financial information. Some companies that have popularized electronic purchase transactions include eBay, Amazon, and Buy.com.

In known online transactions, at the time that a purchase is made, the purchaser must provide credit card or other financial information to the merchant in order to provide the funds required to complete the transaction. This is typically provided in a “checkout” phase of the transaction. The credit card or other financial information is used to authorize the transaction, and is also used to perform risk detection and assessment.

There have been some advances in terms of using online bill payments as a means for fulfilling an online purchase. In these systems, a customer can complete an online, or electronic, purchase transaction without having to newly transmit any sensitive banking or credit card information.

In one of these transactions an electronic bill is sent to the purchaser after a purchase is initiated by a purchaser, perhaps by electronic mail. The purchaser can then direct his financial institution's bill payment system to pay the electronic bill. Unfortunately, this requires individual transaction management by the purchaser for each transaction because the purchaser must separately instruct the bill payment system to pay after each transaction approved by the purchaser. This makes existing bill payment system funded transactions cumbersome.

Embodiments of the present invention provide solutions to these and other problems.

### BRIEF DESCRIPTION OF THE INVENTION

In one embodiment, a system for initiating a payment to a merchant from a bill payment system for a purchaser in an electronic purchase transaction is provided, where the purchaser is a subscriber of the bill payment subsystem. The system may include a gateway subsystem. The gateway subsystem may receive electronic purchase transaction information. The electronic purchase transaction information may include a payment request authorized by the purchaser, and an identifier associated with the merchant. The gateway subsystem may also determine that the purchaser is registered with the gateway subsystem. The gateway subsystem may further send the payment request to the bill payment subsystem of which the purchaser is the subscriber. The gateway subsystem may additionally receive a payment notification from the bill payment subsystem. The gateway subsystem may moreover cause a first payment to be made from a first account associated with the gateway subsystem to a second account associated with the merchant.

In another embodiment, a non-transitory computer-readable medium is provided. The non-transitory computer-readable medium may have an executable program stored thereon for initiating a payment to a merchant from a bill payment system for a purchaser in an electronic purchase transaction, where the purchaser is a subscriber of the bill payment subsystem. The executable program may instruct at least one processor to receive electronic purchase transaction information. The electronic purchase transaction information may include a payment request authorized by the purchaser, and an identifier associated with the merchant. The executable program may also instruct at least one processor to determine that the purchaser is listed in a registration database, and send the payment request to the bill payment subsystem of which the purchaser is the subscriber. The executable program may further instruct at least one processor to receive a payment notification from the bill payment subsystem, and cause a first payment to be made from a first account associated with the gateway subsystem to a second account associated with the merchant.

In another embodiment, a method for initiating a payment to a merchant from a bill payment system for a purchaser in an electronic purchase transaction is provided, where the purchaser is a subscriber of the bill payment subsystem. The method may include receiving, at a gateway subsystem, electronic purchase transaction information. The electronic purchase transaction information may include a payment request authorized by the purchaser, and an identifier associated with the merchant. The method may also include determining that the purchaser is registered with the gateway subsystem. The method may further include sending the payment request to the bill payment subsystem of which the purchaser is the subscriber. The method may additionally include receiving a payment notification from the bill payment subsystem. The method may moreover include causing a first payment to be made from a first account associated with the gateway subsystem to a second account associated with the merchant.

### BRIEF DESCRIPTION OF THE DRAWINGS

The present invention is described in conjunction with the appended figures:

FIG. 1 illustrates a system in one embodiment of the invention for initiating a payment to a merchant from a bill payment system for a purchaser in an electronic purchase transaction;

FIG. 2 illustrates a method of one embodiment of the invention for initiating a payment to a merchant from a bill payment system for a purchaser in an electronic purchase transaction; and

FIG. 3 illustrates a block diagram of an exemplary computer system capable of being used in at least some portion of the apparatuses or systems of the present invention, or implementing at least some portion of the methods of the present invention.

In the appended figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION OF THE INVENTION

The ensuing description provides exemplary embodiments only, and is not intended to limit the scope, applicability or configuration of the disclosure. Rather, the ensuing description of the exemplary embodiments will provide those skilled in the art with an enabling description for implementing one or more exemplary embodiments. It being understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that various embodiments may be practiced with or without any given specific detail of any specifically described embodiment.

Circuits, systems, networks, processes, and other elements in the invention may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but could have additional steps not discussed or included in a figure. Furthermore, not all operations in any particularly described process may occur in all embodiments. A process may correspond to a method, a function, a procedure, a subroutine, a subprogram, etc.

The term “machine-readable medium” includes, but is not limited to transitory or non-transitory, portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments of the invention may be implemented, at least in part, either manually or automatically. Manual or automatic implementations may be executed, or at least assisted, through the use of machines, hardware, software, firmware, middleware, microcode, hardware description languages, or any combination thereof When implemented in software, firmware, middleware or microcode, the program code or code segments to perform the necessary tasks may be stored in a machine readable medium. A processor(s) may perform the necessary tasks.

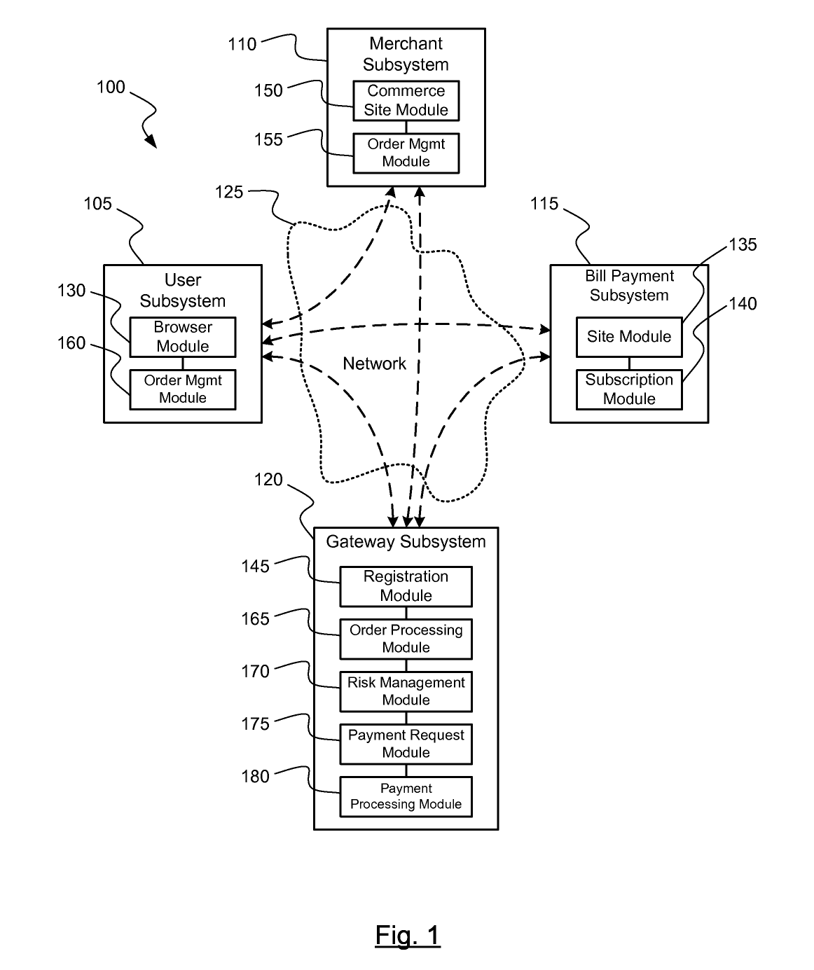

Turning now to FIG. 1, one embodiment of a system 100 of the invention is shown. System 100 may include a user subsystem 105, a merchant subsystem 110, a bill payment subsystem 115, and a gateway subsystem 120. A network 125, perhaps the Internet, may communicatively couple each of the subsystems.

User subsystem 105 may be used by a user to conduct various activities with system 100. First, user subsystem 105 may be used to access bill payment subsystem 115 prior to any purchase taking place between the user and a particular merchant. A user may utilize browser module 130 to access an interface of online bill payment subsystem 115 as presented by site module 135. For example, the user may view a web page of the entity operating the bill payment system. Such an entity may be a financial institution such as a bank or credit card company, or a financial services provider such as a money transfer service. Through such access a user may subscribe to bill payment subsystem 115.

Bill payment subsystem 115 allows a user to pay bills, both received at, or independently from, bill payment subsystem 115. The user may have the option in bill payment subsystem 115 to identify certain billers as being authorized to have their bills auto-paid. “Auto-paid” meaning that the user need not confirm that a bill from the authorized biller should be paid once received, but instead that once a bill from the biller is received, bill payment subsystem 115 should proceed to pay the bill without further instruction by the user. In some embodiments, the user may specify whether regularly occurring and/or non-regularly occurring bills are authorized for auto-payment. The user may then add gateway subsystem 120, and/or an entity associated with it, as an authorized auto-paid biller. All of this and other pertinent information regarding the user and his authorized auto-paid billers may be stored in subscription module 140.

Bill payment system 115 may or may not then send an indication to gateway subsystem 120 informing gateway subsystem 120 that gateway subsystem 120, and/or an entity associated with it, is now preauthorized for auto-payment of bills received from it. In some embodiments, limits on the size (i.e., monetary amount) and/or type of purchases (i.e., types of goods and/or services) which are pre-authorized may exist, either at the behest of the user, or based on bill payment subsystem 115 operating protocols. In some embodiments, the bill payment subsystem may run a risk analysis, as known in the art, on the user to determine auto-payment limits. In any case, the established limits may or may not be communicated to gateway subsystem 120.

In some embodiments, the user may then access gateway subsystem 120, possible via browser module 130. In some embodiments, the user may register with gateway subsystem 120 via registration module 145. In other embodiments, the user may be registered with gateway subsystem 120 based on an indication received from bill payment subsystem 115. In some embodiments, the user may need to confirm with gateway subsystem 120 that a notification received from bill payment subsystem 115 should be interpreted as an instruction to register the user with gateway subsystem 120. In any case, gateway subsystem 120 may or may not confirm with bill payment subsystem 115 that gateway subsystem 120, and/or an entity associated with it, is confirmed as a pre-authorized biller by the user (or more specifically, a pre-authorized non-regularly occurring biller). Gateway subsystem 120 may possibly do this by conducting test billings for very small amounts (i.e., $0.03, $0.14, etc.) to determine if gateway subsystem 120 is properly confirmed and being auto-paid the same amounts by bill payment subsystem 115. Gateway subsystem 120 may also refund these amounts back to the user's bill payment account as well.

Next, browser module 130 may allow the user to communicate with an online merchant site presented by commerce site module 150. For example, a potential purchaser may use a web browser to visit a merchant's World Wide Web store. Note that as used herein, the term “merchant” is understood to include not only providers of goods, but providers of services (i.e., maintenance providers (i.e. plumbers, etc.), construction contractors, landscapers, etc.), which may be purchased in a like manner to goods.

The user may decide to make a purchase from merchant, and order management modules 155, 160 at both user subsystem 105 and merchant subsystem 110 may coordinate the agreement to purchase. This may include obtaining the necessary authorizations from the purchaser, and the necessary confirmations from the merchant that such goods/services can be provided. Information regarding the purchase may also be stored by each of order management modules 155, 160.

Once the transaction is in process, the user/purchaser may then inform merchant subsystem 110 that gateway subsystem 120 will be used to pay for the purchase. In some embodiments, this may involve user subsystem 105 providing an account number, authentication value, or other information identifying user's account at gateway subsystem 120 to merchant subsystem 110. In turn, merchant subsystem 110 may then communicate purchase transaction information with gateway subsystem 120 to effectuate payment from gateway subsystem 120 to merchant subsystem 110. The purchase transaction information may include gateway subsystem 120 account information, a payment request authorized by the purchaser for a specific amount, as well as an identifier associated with the merchant (possibly a financial account number associated with the merchant). As used herein, when an account is said to be “associated with” a party, it is understood that the account is controlled by, and the balance the property of, the party.

In other embodiments, merchant subsystem 110 will not receive any information regarding the user's arrangement with gateway subsystem 120. Instead, user subsystem 105 may inform gateway subsystem 120 of the purchase transaction information described above. In these embodiments, the merchant subsystem 110 may merely be informed that a payment is to be expected from gateway subsystem 120. In yet other embodiments, both user subsystem 105 and merchant subsystem 110 may inform gateway subsystem 120 of the purchase transaction information, and gateway subsystem 120 may verify that the information provided by each subsystem matches before proceeding with the transaction. Gateway subsystem 120 may store the purchase transaction information at an order processing module 165.

Once the above has occurred, gateway subsystem 120 conducts a number of steps to possibly make the payment to the merchant requested by the user. First, gateway subsystem 120 determines whether or not the purchaser is registered with the system. Gateway subsystem 120 may also conduct a risk analysis on the transaction using risk management module 170. This may involve determining whether limits, as possibly communicated earlier by bill payment subsystem 115, apply to the requested transaction. If independent risk analysis, or risk analysis supplemented by other sources/systems indicates that the transaction should not be processed, a declination message may be sent to user subsystem 105 and/or merchant subsystem 110. Likewise, if gateway subsystem 120 determines that some aspect of the transaction exceeds a known limit on pre-authorized auto-payments by bill payment subsystem 115, a declination message may also be passed. This declination may be communicated by each subsystem to their respective purchaser or merchant.

If gateway subsystem 120 determines that the transaction should proceed, payment request module 175 sends a request to bill payment subsystem 115 to be paid the amount specified in the purchase transaction information. Bill payment subsystem 115 receives this request, and so long as it is within whatever limits are established for the purchaser, and/or risk analysis does not raise any flags concerning the transaction, bill payment subsystem 115 initiates the transaction and notifies gateway subsystem 120 of the payment. This notification may be an affirmation that a payment has been made, will soon be made, or is guaranteed, from an account associated with the purchaser, of which bill payment subsystem 115 may draw funds, to an account associated with gateway subsystem 120, and/or an entity associated with it. Gateway subsystem 120 may then cause a payment to be made from its account to that of the merchant, thereby completing the payment side of the transaction. Gateway subsystem 120 may also at this point, or some point prior, transmit a payment confirmation message to merchant subsystem 110.

In the case where gateway subsystem 120 determines that a transaction will exceed or fall outside pre-authorized auto-pay limits set by either gateway subsystem 120 or bill payment subsystem 115, gateway subsystem 120 may send a supplemental message to the purchaser instructing them that though the transaction will be sent as a bill to bill payment subsystem 115, the user will need to separately direct bill payment subsystem 115 to initiate payment of the bill. In some embodiments, gateway subsystem 120 will not be aware that a limit of bill payment subsystem 115 is exceeded by a billed transaction submitted to bill payment subsystem 115 and expected to be auto-paid. Instead, gateway subsystem 120 may receive a postponement message from bill payment subsystem 115, which may in turn cause gateway subsystem 120 to send a supplemental message, as above, to the purchaser.

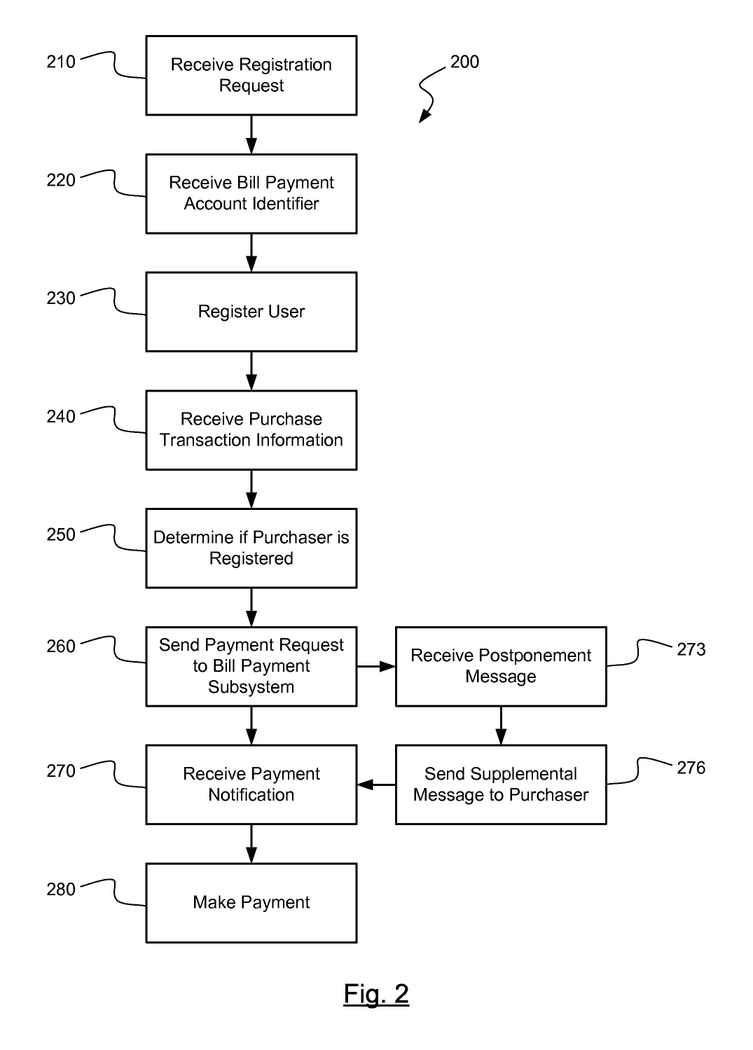

FIG. 2 is a block diagram 200 of a method of the invention as described above in relation to system 100. At step 210, a registration request is received, possibly from a user, or from a bill payment subsystem on behalf of the user. At step 220, a bill payment account identifier is received. This bill payment account identifier allows system 100 to identify where transaction requests from the user should be directed to at the bill payment subsystem. The bill payment account identifier may be transmitted with or within the registration request. At block 230, the user is registered if system 100 determines that the user is eligible for use of a gateway subsystem which is pre-authorized to receive payments on bills sent to the user's bill payment system.

At block 240, a user has initiated a transaction with a merchant and purchase transaction information is received. At block 250, it is determined whether or not the purchaser is registered with system 100. If the purchaser is so registered, then at block 260, a payment request is sent to the bill payment subsystem of the purchaser.

Typically, at block 270, a payment notification would then be received, indicating that the bill payment system had processed the transaction. However, in some cases, as discussed above, a postponement message may instead be received from the bill payment subsystem at block 273. A supplemental message to the purchaser may then be sent at block 276 informing the purchaser to affirm the payment request with his or her bill payment subsystem.

At block 280, system 100 makes payment to the merchant. Notifications may be sent ahead of time, concurrently, or thereafter, to the merchant, as well as the purchaser.

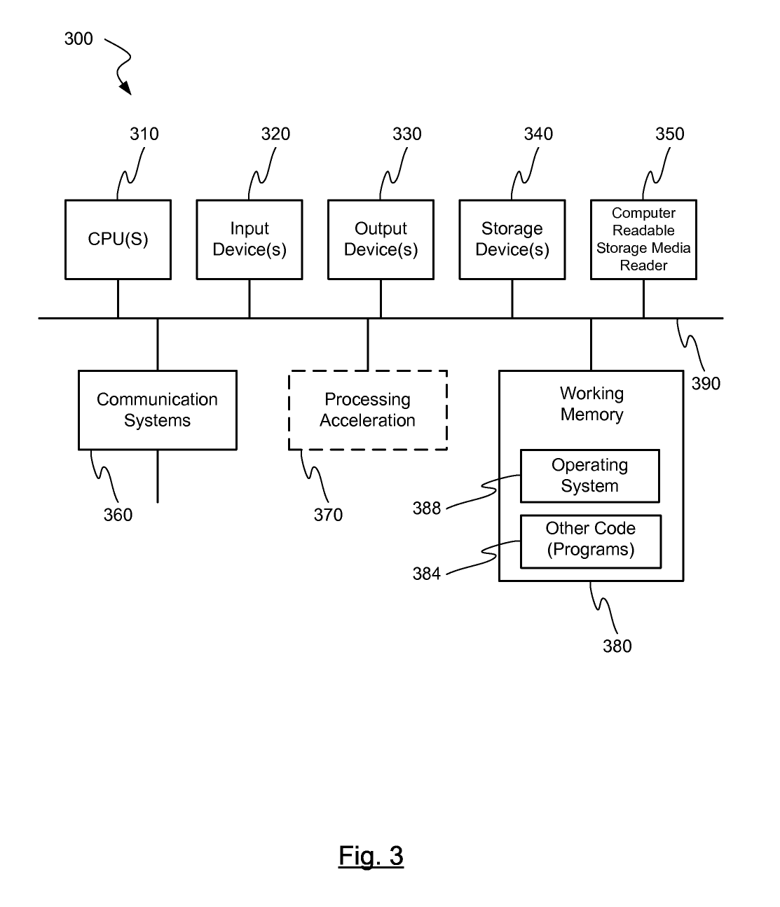

FIG. 3 is a block diagram illustrating an exemplary computer system 300 in which embodiments of the present invention may be implemented. This example illustrates a computer system 300 such as may be used, in whole, in part, or with various modifications, to provide the functions of the merchant subsystem, user subsystem, bill payment subsystem, gateway subsystem, and/or other components of the invention such as those discussed above. For example, various functions of the gateway subsystem may be controlled by computer system 300, including, merely by way of example, receiving electronic purchase transaction information, determining registration status of a purchaser, sending payment requests, receiving payment notifications, causing payments to be made, etc.

Computer system 300 is shown comprising hardware elements that may be electrically coupled via a bus 390. The hardware elements may include one or more central processing units 310, one or more input devices 320 (e.g., a mouse, a keyboard, etc.), and one or more output devices 330 (e.g., a display device, a printer, etc.). Computer system 300 may also include one or more storage device 340. By way of example, storage device(s) 340 may be disk drives, optical storage devices, solid-state storage device such as a random access memory (“RAM”) and/or a read-only memory (“ROM”), which can be programmable, flash-updateable and/or the like.

Computer system 300 may additionally include a computer-readable storage media reader 350, a communications system 360 (e.g., a modem, a network card (wireless or wired), an infra-red communication device, Bluetooth™ device, cellular communication device, etc.), and working memory 380, which may include RAM and ROM devices as described above. In some embodiments, computer system 300 may also include a processing acceleration unit 370, which can include a digital signal processor, a special-purpose processor and/or the like.

Computer-readable storage media reader 350 can further be connected to a computer-readable storage medium, together (and, optionally, in combination with storage device(s) 340) comprehensively representing remote, local, fixed, and/or removable storage devices plus storage media for temporarily and/or more permanently containing computer-readable information. Communications system 360 may permit data to be exchanged with a network, system, computer and/or other component described above.

Computer system 300 may also comprise software elements, shown as being currently located within a working memory 380, including an operating system 384 and/or other code 388. It should be appreciated that alternate embodiments of computer system 300 may have numerous variations from that described above. For example, customized hardware might also be used and/or particular elements might be implemented in hardware, software (including portable software, such as applets), or both. Furthermore, connection to other computing devices such as network input/output and data acquisition devices may also occur.

Software of computer system 300 may include code 388 for implementing any or all of the function of the various elements of the architecture as described herein. For example, software, stored on and/or executed by a system such as computer system 300, can provide the functions of the merchant subsystem, user subsystem, bill payment subsystem, gateway subsystem, and/or other components of the invention such as those discussed above. Methods implementable by software on some of these components have been discussed above in more detail.

A number of variations and modifications of the embodiments described herein can also be used within the scope of the invention. For example, purchases made by a purchaser at physical “brick-and-mortar” merchant or service provider locations may be paid for via the systems and methods of the invention. In other embodiments, payments on obligations such as loans, and/or money transfers may be funded via the systems and methods of the invention.

The invention has now been described in detail for the purposes of clarity and understanding. However, it will be appreciated that certain changes and modifications may be practiced within the scope of the appended claims.

What is claimed is:

1. A system for initiating a payment to a merchant from a bill payment system for a purchaser in an electronic purchase transaction, the purchaser being a subscriber of the bill payment subsystem, wherein the system comprises:
a gateway subsystem for:
receiving electronic purchase transaction information, the electronic purchase transaction information including:
a payment request authorized by the purchaser; and
an identifier associated with the merchant;
determining that the purchaser is registered with the gateway subsystem;
sending the payment request to the bill payment subsystem of which the purchaser is the subscriber;
receiving a payment notification from the bill payment subsystem; and
causing a first payment to be made from a first account associated with the gateway subsystem to a second account associated with the merchant.

2. The system for initiating the payment from the bill payment system for the purchaser in the electronic purchase transaction of claim 1, wherein receiving electronic purchase transaction information comprises:
receiving electronic purchase transaction information from a user subsystem operated by the purchaser.

3. The system for initiating the payment from the bill payment system for the purchaser in the electronic purchase transaction of claim 1, wherein receiving electronic purchase transaction information comprises:
receiving electronic purchase transaction information from a merchant subsystem operated by the merchant.

4. The system for initiating the payment from the bill payment system for the purchaser in the electronic purchase transaction of claim 1, wherein receiving electronic transaction information comprises:
receiving electronic purchase transaction information from a user subsystem operated by the purchaser;
receiving electronic purchase transaction information from a merchant subsystem operated by the merchant; and
verifying that the electronic purchase transaction information from the user subsystem matches the electronic purchase transaction from the merchant subsystem.

5. The system for initiating the payment from the bill payment system for the purchaser in the electronic purchase transaction of claim 1, wherein the identifier associated with the merchant comprises:
an account number of the second account.

6. The system for initiating the payment from the bill payment system for the purchaser in the electronic purchase transaction of claim 1, wherein the payment notification comprises:
an affirmation that a second payment has been made from a third account associated with the purchaser to the first account associated with the gateway subsystem.

7. The system for initiating the payment from the bill payment system for the purchaser in the electronic purchase transaction of claim 1, wherein determining that the purchaser is registered with the gateway subsystem comprises:
determining that the purchaser subscribes to the bill payment system; and
determining that the purchaser has approved the gateway subsystem as an auto-pay payee in the bill payment subsystem.

8. The system for initiating the payment from the bill payment system for the purchaser in the electronic purchase transaction of claim 7, wherein the determining that the purchaser has approved the gateway subsystem as an auto-pay payee in the bill payment subsystem comprises:
determining that the purchaser has, prior to the gateway subsystem receiving the electronic purchase transaction information, approved the gateway subsystem as an auto-pay biller in the bill payment subsystem.

9. The system for initiating the payment from the bill payment system for the purchaser in the electronic purchase transaction of claim 1, wherein sending the payment request to the bill payment subsystem of which the purchaser is the subscriber occurs:
in response, at least in part, to determining that the purchaser is registered with the gateway subsystem.

10. The system for initiating the payment from the bill payment system for the purchaser in the electronic purchase transaction of claim 1, wherein causing a first payment to be made from a first account associated with the gateway subsystem to a second account associated with the merchant occurs:
in response, at least in part, to receiving the payment notification from the bill payment subsystem.

11. The system for initiating the payment from the bill payment system for the purchaser in the electronic purchase transaction of claim 1, wherein causing a first payment to be made from a first account associated with the gateway subsystem to a second account associated with the merchant occurs:
in response, at least in part, to receiving a second payment from a third account associated with the purchaser to the first account associated with the gateway subsystem.

12. A non-transitory computer-readable medium with an executable program stored thereon for initiating a payment to a merchant from a bill payment system for a purchaser in an electronic purchase transaction, the purchaser being a subscriber of the bill payment subsystem, wherein the executable program instructs at least one processor to:
receive electronic purchase transaction information, the electronic purchase transaction information including:
a payment request authorized by the purchaser; and
an identifier associated with the merchant;
determine that the purchaser is listed in a registration database;
send the payment request to the bill payment subsystem of which the purchaser is the subscriber;
receive a payment notification from the bill payment subsystem; and
cause a first payment to be made from a first account associated with the gateway subsystem to a second account associated with the merchant.

13. The non-transitory computer-readable medium of claim 12, wherein the executable program further instructs at least one processor to:
receive a registration request from the purchaser;
receive a bill payment account number from the purchaser; and
register the purchaser by listing the purchaser in the registration database with the bill payment account number.

14. The non-transitory computer-readable medium of claim 12, wherein the executable program further instructs at least one processor to:
receive a registration request from the purchaser;
receive a bill payment account number from the bill payment subsystem; and
register the purchaser by listing the purchaser in the registration database with the bill payment account number.

15. The non-transitory computer-readable medium of claim 12, wherein the executable program further instructs at least one processor to:
receive a postponement message from the bill payment subsystem; and
send a supplemental message to the user subsystem which instructs the purchaser to separately direct the bill payment subsystem to initiate a second payment from a third account associated with the purchaser to the first account associated with the gateway subsystem.

16. A method for initiating a payment to a merchant from a bill payment system for a purchaser in an electronic purchase transaction, the purchaser being a subscriber of the bill payment subsystem, wherein the method comprises:
receiving, at a gateway subsystem, electronic purchase transaction information, the electronic purchase transaction information including:
a payment request authorized by the purchaser; and
an identifier associated with the merchant;
determining that the purchaser is registered with the gateway subsystem;
sending the payment request to the bill payment subsystem of which the purchaser is the subscriber;
receiving a payment notification from the bill payment subsystem; and
causing a first payment to be made from a first account associated with the gateway subsystem to a second account associated with the merchant.

17. The method for initiating the payment from the bill payment system for the purchaser in the electronic purchase transaction of claim 16, wherein receiving electronic purchase transaction information comprises:
receiving electronic purchase transaction information from a user subsystem operated by the purchaser.

18. The method for initiating the payment from the bill payment system for the purchaser in the electronic purchase transaction of claim 16, wherein receiving electronic purchase transaction information comprises:
receiving electronic purchase transaction information from a merchant subsystem operated by the merchant.

19. The method for initiating the payment from the bill payment system for the purchaser in the electronic purchase transaction of claim 16, wherein the payment notification comprises:
an affirmation that a second payment has been made from a third account associated with the purchaser to the first account associated with the gateway subsystem.

20. The method for initiating the payment from the bill payment system for the purchaser in the electronic purchase transaction of claim 16, wherein determining that the purchaser is registered with the gateway subsystem comprises:
determining that the purchaser subscribes to the bill payment system; and
determining that the purchaser has approved the gateway subsystem as an auto-pay payee in the bill payment subsystem.
